(19) United States
(12) Patent Application Publication
(10) Pub. No.: US 2004/0100225 A1
(43) Pub. Date: May 27, 2004

(54) Cooling and control system for battery charging

(76) Inventors: Robert Miles Neil, Greenville, NC (US); David E. Krueger, Mulino, OR (US)

Correspondence Address: MARGER JOHNSON & McCOLLOM, P.C., 1030 S.W. Morrison Street, Portland, OR, 97205, US

(21) Appl. No.: 10/717,950

(22) Filed: Nov. 19, 2003

Related U.S. Application Data
(60) Provisional application No. 60/428,133, filed on Nov. 20, 2002.

(51) Int. Cl. H02J 7/00

(52) U.S. Cl. 320/109

(57) ABSTRACT

A battery operated vehicle includes a battery for powering an electric motor. A fan is installed in the vehicle and is directed toward the battery. When a battery charger starts charging the battery, a controller automatically activates the fan to cool the battery during the charging session. Switching circuitry in the vehicle automatically connects the battery to the fan and disconnects the battery from other vehicle electrical equipment during the charging session. Operating parameters in the vehicle are monitored to more effectively predict remaining battery charge.

### BACKGROUND

Electrically powered vehicles use one or more batteries that must be periodically recharged. Electrically powered industrial vehicles may need to be operated around the clock. In these around the clock industrial applications, discharged batteries have to be physically replaced one or more times a day with fully charged batteries. Industrial vehicle batteries, such as the batteries used to power lift trucks, are quite large. Having to periodically replace discharged batteries with fully charged batteries is time consuming and requires additional equipment and personnel to move the batteries in and out of the lift trucks. For example, a special crane apparatus is typically required to lift the discharged battery out of the lift truck and then place another fully charged battery back into the lift truck. Having to purchase several backup batteries also increases operating expense.

In some applications, the discharged batteries are left in the vehicle. A battery charger is then attached to the battery and the battery recharged while the vehicle is not in use. This recharging time can keep the vehicle out of commission for substantial periods of time.

The present invention addresses this and other problems associated with the prior art.

### SUMMARY OF THE INVENTION

A battery operated vehicle includes a battery for powering an electric motor. A fan is installed in the vehicle and is directed toward the battery. When a battery charger starts charging the battery, a controller automatically activates the fan to cool the battery during the charging session. Switching circuitry in the vehicle automatically connects the battery to the fan and disconnects the battery from other vehicle electrical equipment during the charging session. Operating parameters in the vehicle are monitored to more effectively predict remaining battery charge.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a diagram of a battery operated lift truck that includes an improved battery charging system.

FIG. 2 is an electrical diagram for the battery charging system.

FIG. 3 is an electrical diagram showing how the battery charging system can be used for downloading vehicle operating data.

FIG. 4 is a flow diagram showing how monitored vehicle operation parameters can be used to predict how long a battery can operate a vehicle.

### DETAILED DESCRIPTION

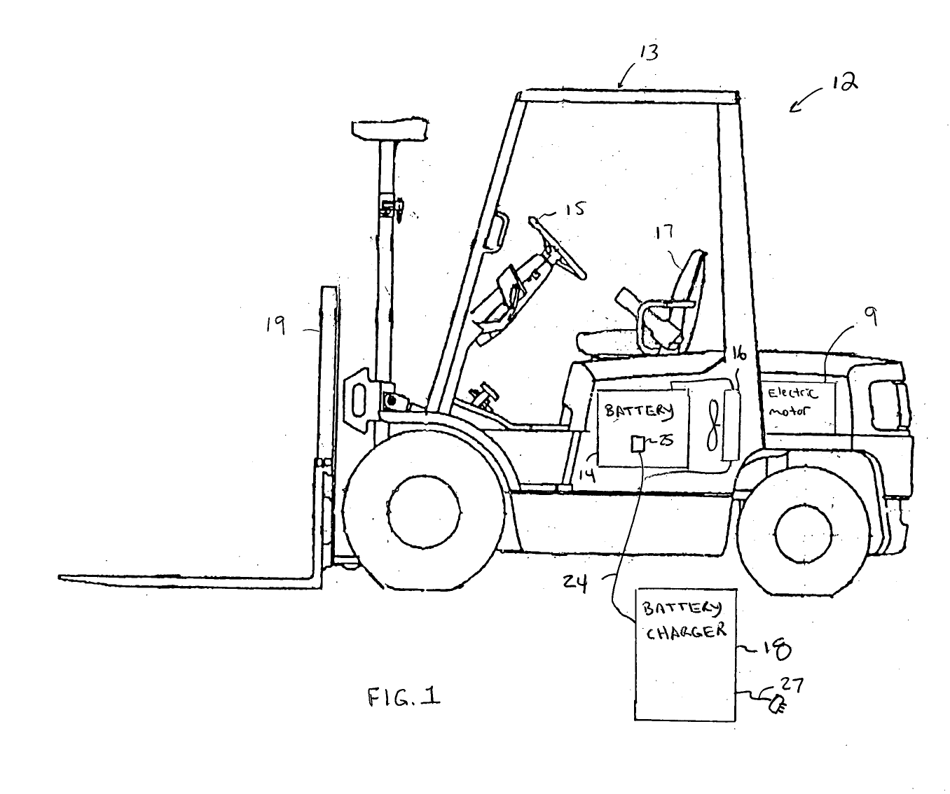

FIG. 1 shows an electrically powered lift truck 12. The lift truck 12 is conventional and includes a forklift 19 that moves up and down in a vertical direction. A cab 13 of the lift truck 12 is occupied by an operator (not shown) and includes a steering wheel 15 for steering the truck 12. A battery 14 is located somewhere in the lift truck 12 and powers an electric motor 9 and other electrically powered vehicle equipment.

In one embodiment, the battery 14 is located underneath the seat 17 in the cab 13. However, the battery may be located anywhere within the lift truck 12. The battery charging system described below is shown used with the lift truck battery 14. However, it should be understood that this is just one preferred embodiment. The battery charging system described below can be used with different types of batteries in different types of vehicles.

A battery charger 18 is used to recharge the battery 14. An electrical cable 24 is plugged into a socket 25 on the vehicle 12. The charger 18 is connected to an external power source (not shown) with electrical cable 27. The charger 18 converts Alternating Current (AC) power received from electrical cable 27 into a Direct Current (DC) or AC current that is used for recharging battery 14.

One problem with this charging arrangement is that the vehicle 12 can not be operated while the battery 14 is being charged and a relatively long period of time may be required to charge battery 14. Any reduction in this charge time would increase the available operating time-for vehicle 12. Battery charge time is limited by the amount of heat generated during the battery charging process. If the battery is charged too quickly, the battery can overheat and possibly be damaged.

An improved battery charging system in FIG. 1 reduces the required charging time by activating a fan 16 during and possibly after the charging session. The fan 16 is permanently installed in the lift truck 12 and is activated during the battery charging session. The fan 16, removes some of the heat that is typically generated by battery 14 during the charging process. This allows the battery 14 to be charged faster since the reduced temperature allows more energy can be applied to the battery 14 by the charger 18. This reduced charging time allows the battery 14 to be recharged during work breaks preventing the battery 14 from having to be replaced during work shifts.

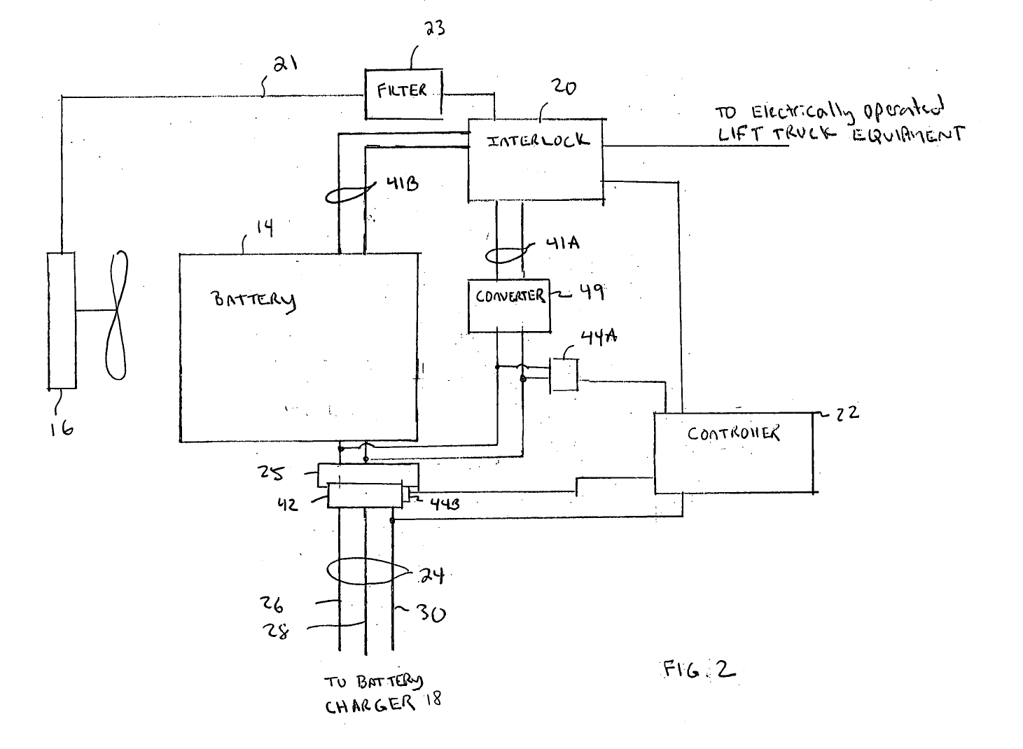

FIG. 2 shows in more detail how the battery charging system operates. Whenever the battery 14 needs to be recharged, the cable 24 from charger 18 is plugged into the socket 25 located in vehicle 12. The cable 24 may include a positive power line 26 and a negative power line 28. The charger 18 may also include a control line 30 that provides electrical communication with a controller 22 located either on the battery 14 or in some other location in the vehicle 12.

The controller 22 detects a signal on control line 30 that indicates the charger 18 is connected or beginning to charge the battery 14. Upon detecting the signal on control line 30, the controller 22 activates an electrical interlock switch 20. Upon detecting the beginning of a battery charging session, the controller 22 causes the electrical interlock switch 20 to maintain or connect battery 14 to fan 16 via connection 41B and disconnect the battery 14 from other electrical equipment in vehicle 12. For example, interlock 20 may disconnect the battery 14 from the vehicle electric motor 9 (FIG. 1).

In another embodiment, when the beginning of the battery charging session is detected, the controller 22 directs the interlock switch 20 to connect power directly from the battery charger 18 to the fan 16 via power lines 41A. If the fan 16 is powered directly from the battery charger 18, a power converter 49 might be used to convert the output from the battery charger 18 into a voltage and current rated for operating the fan 16.

A filter 23 may be coupled into line 21 to filter out electrical surges that may be generated by the battery charger 18 while charging battery 14. The controller 22 may be powered by a separate backup battery (not shown) or may receive power from battery 14.

As soon as the charger 18 starts charging battery 14, the controller 22 enables interlock switch 20 to supply power from battery 14 or directly from the battery charger 18 to the fan 16. The fan 16 begins to blow air, removing heat from the battery 14 during the charging process. This allows the charger 18 to charge battery 14 faster using more energy than what would normally be possible.

In another embodiment, a sensor or switch 44B is connected to socket 25 and detects the start of the battery charging session when an electrical plug 42 on cable 42 is mechanically or electrically engaged with socket 25. In a different embodiment, a sensor 44A senses the beginning of the battery charging session when power from battery charger 18 energizes power lines 41A. Upon receiving a signal from sensor 44A, 44B, or directly from control line 30, the controller 22 activates interlock 20 connecting power from battery 14, or connecting power directly from battery charger 18, to the fan 16 while disconnecting the battery 14 from the other vehicle equipment.

The controller 20 senses the completion of the charging process either through control line 30, sensor 44A, or sensor 44B either when the plug 42 is disconnected from socket 25 or when the battery charger 18 stops supplying charge to battery 14. The controller 22 then automatically directs the interlock 20 to reconnect the vehicle electrical equipment to the battery 14. The controller 22 may then direct the interlock switch 20 to correct or maintain power from battery 14 to the fan 16 via lines 41B for some period of time after the completion of the charging session to remove any remaining residual heat from the battery 14.

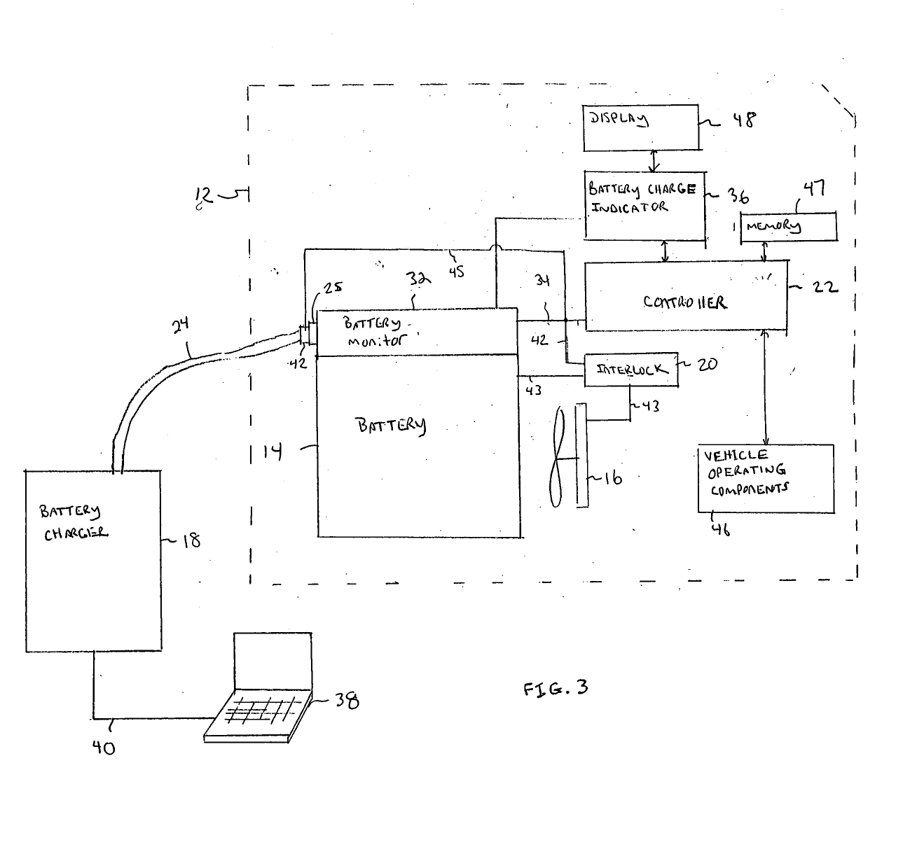

FIG. 3 shows another aspect of the charging system. A battery monitor 32 may exist on some batteries 14 and is used by the battery charger 18 while charging battery 14. The battery monitor 32 can control battery charging by battery charger 18 according to measured battery temperature and other battery parameters. Battery monitor 32 and battery chargers that vary charging characteristics according to monitored battery parameters are well known and therefore are not described in further detail.

The battery monitor 32 can alternatively activate the fan 16 during a battery charging session. Because the fan 16 is blowing during the battery charging session, the battery monitor 32 will monitor a lower battery temperature. This allows the battery monitor 32 to direct the battery charger 18 to charge the battery 14 at a higher energy level. As a result, the battery 14 will be charged more quickly.

Either the battery monitor 32, or the controller 22 as described above in FIG. 2, can detect when the battery charging session begins. Battery charging is detected internally by the battery monitor 32 or by the controller 22 either by monitoring power or a control signal in the power cable 24 or by a mechanical switch in connector assembly 25 and 42. The monitor 32 or controller 22 accordingly activates a control signal 42 that causes interlock switch 20 to connect power line 43 from battery 14 or directly from the battery charger 18 to fan 16. The fan 16 is activated during the charging process and possibly for a predetermined period after the charging process.

Another aspect of the invention includes using the battery monitor 32 to also receive and download vehicle operating parameters from the controller 22. For example, the controller 22 monitors different vehicle operating components 46, such as the operating time for electric motor 9 (FIG. 1). Other information in vehicle operating components 46 may include password identifiers (IDs) for drivers operating the vehicle 12 and fault information.

For example, in some vehicles a vehicle operator has to enter a password into the controller 22 in order to start the vehicle. The controller 22 can store the entered IDs in memory 47. The controller 22 can also track fault information such as a hydraulic fluid failure or a failure of the electric motor 9. For instance, a hydraulic fluid failure could be detected by using a sensor in hydraulic fluid lines that measures the hydraulic fluid pressure. If the hydraulic fluid pressure falls below a predetermined pressure, a failure condition is recorded by controller 22 in memory 47.

An electric motor failure could be detected using a meter that measures the impedance across the electric motor. If the impedance is outside a normal value, a failure could be recorded by controller 22 in memory 47. Alternatively, sensors could notify the controller 22 of a failure when the electric motor 9 does not activate after receiving power from battery 14. Other means for detecting vehicle failures are known and are not described in further detail.

It may be desirable to download this failure and other vehicle and battery information from either battery monitor 32 or controller 22 to a computer 38. The computer 38 can be a laptop, Personal Computer (PC) or any other type of computing device.

In one embodiment, the vehicle information is downloaded from the controller 22 through the battery monitor 32 over the control line 30 in cable 24. Other battery information can also be generated and downloaded directly from the battery monitor 32. The vehicle data and battery data is then downloaded from the battery charger 18 to the computer 38 over an external data line 40, such as a Universal Serial Bus (USB).

Alternatively, the external data line 40 is coupled directly from the controller 22 to the computer 38. The computer 38 can be connected to the battery charger 18 or connected to controller 22 directly or via a network, wireless connection, or some other method. Any of the connections between controller 22, battery, monitor 32, and computer 38 can be through a CAN bus or other type of vehicle communication link. A Local Area Network (LAN) can also be used to couple the battery charger 18 to the computer 38.

Predicting Remaining Battery Charge

It is important to accurately determine the charge remaining in a battery. In industrial applications, such as in lift truck operations, knowing the amount of remaining life left in a vehicle battery may help determine when the lift truck operator can take a break or needs to change batteries. For example, depending on the amount of remaining battery charge, the lift truck operator may be able to conduct a partial recharge during a lunch break that would be enough to keep the lift truck operational for the remainder of the shift. The battery in the lift truck could then be fully charged at the end of the shift. Alternatively, if the same lift truck is used in multiple shifts, the battery could be replaced during the shift change instead of during a shift.

Thus, being able to accurately predict how long the battery can operate a vehicle helps manage when vehicle batteries are recharged or replaced. In addition, it is often detrimental to unnecessarily recharge batteries. For example, battery life can be reduced when the battery is constantly recharged before the remaining charge in the battery is depleted. Accurately identifying how long a battery can operate a vehicle would reduce the number of unnecessary recharges.

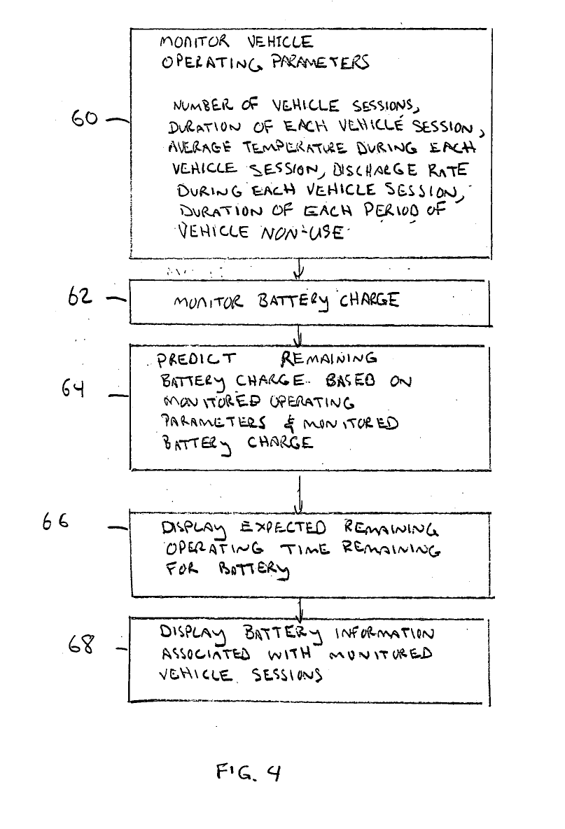

Referring to FIGS. 3 and 4, the controller 22 is used to adjust battery charge measurements to more accurately estimate remaining battery charge. A battery charge indicator 36 in the vehicle 12 is coupled to the battery monitor 32. The battery monitor 32 sends battery charge status information to the battery charge indicator 36 that then displays the charge status on a display 48. Alternatively, the battery status and charge information is read from the battery monitor 32 by the controller 22 and then forwarded to the battery charge indicator 36. The monitor 32 or controller 22 predicts long the battery can operate the vehicle and outputs the predicted remaining time to indicator 36. The remaining vehicle operation time is then displayed on display 48 for viewing by the vehicle operator.

Referring to FIG. 4, in block 60 the controller 22 or battery monitor 32 monitors certain operational information associated with the vehicle components 46. For example, the controller 22 can keep track of any combination of the following: the number of vehicle sessions, the duration and time of each vehicle session, average ambient temperature for each vehicle session, battery discharge rate during each vehicle session, and time periods of vehicle non-use between each vehicle session. A vehicle session in one instance refers to electric motor operation. For example, the periods when the electric motor is energized by the battery and moving or idling the vehicle. Vehicle sessions are easily determined by monitoring current or voltage from the battery 14 to the electric motor 9.

The battery monitor 32 or the controller 22 periodically monitors the amount of battery charge in block 62. Charge is determined by measuring battery voltage or current. A prediction of remaining time the battery can operate the vehicle is calculated in block 64 based on both the measured remaining battery charge and on the monitored vehicle operating parameters. The battery may have charge characteristics that change over time or change depending on types of vehicle operation. Therefore the monitored vehicle operating parameters are used to help better estimate how long the battery can continue to operate the vehicle.

For example, the controller 22 may monitor the vehicle for a previous month of operation. It may be determined that at a current battery charge level and for a current operational routine of the vehicle that the battery can continue to operate the vehicle for approximately four more hours.

Specifically, the controller may detect that the battery has approximately half of its remaining charge. Further, the controller may also over the last month monitor the vehicle as operating generally at constant one hour sessions with ten minute shut-off periods between each one hour session. With this previously monitored and stored profile of vehicle operation, the controller 22 may determine that at half charge, and with the vehicle operating at one hour periods with ten minute breaks between each period, that the battery will have enough charge to operate the vehicle for four more hours.

The four hour remaining time period is displayed on the display 48 (FIG. 3) and then reduced proportionally with additional operation of the vehicle. If the vehicle is completely or partially recharged, the controller adjusts the available operation time shown in display 48 according to the battery measurement after the charge session. If the vehicle skips one of the one hour breaks, the controller 22 also readjusts the predicted operation time.

The remaining vehicle operation time can be further adjusted according to other monitored vehicle parameters. For example, the controller may determine that at colder ambient temperatures, the amount of time the battery 14 can continue to operate the vehicle 12 may be reduced by ten percent. The controller measures the temperature and adjusts the predicted remaining vehicle operation time according to the measured temperature. In another example, the controller may determine that after a long period of non-use, such as more than two hours, that the operation time for a measured battery charge value may increase by thirty minutes. The controller accordingly increases the predicted remaining vehicle operation time by thirty minutes.

The controller in block 68 can also display certain charge information associated with particular vehicle sessions. For example, in many industrial applications the battery powered vehicle is operated more or less in the same daily routine. For example, the vehicle operates in a shift that includes three one hour sessions in the morning and three one hour sessions in the afternoon, separated by a one hour break at lunch. Depending on the current monitored charge, and the other monitored parameters described above, the controller can determine if the battery has enough charge to operate the vehicle for the next one hour session, or for all the remaining sessions for the remainder of the shift.

This information would be displayed to the vehicle operator in block 68. If the battery would not likely have enough charge to complete a shift, this information would be communicated to the vehicle operator on display 48. This could then prompt the vehicle operator to charge the vehicle during the lunch break. If the predicted operation time indicates the battery cannot operate the vehicle for even the next one hour shift, then the operator can replace the battery during the next break. Thus, the vehicle operator has a better idea of how long the vehicle can be operated before recharging or replacing the battery.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. We claim all modifications and variation coming within the spirit and scope of the following claims.

1. A battery charge system for a vehicle, including:
a controller that detects a charging session where a battery in the vehicle is charged by an external battery charger, the controller upon detecting the charging session activating a fan located in the vehicle for cooling the battery during the charging session.

2. A system according to claim 1 including a sensor that identifies a start of the charging session either when the external battery charger connects to the battery or when the battery charger starts charging the battery.

3. A system according to claim 1 including an interlock switch that connects the battery charger to the fan or connects the battery to the fan during the charging session.

4. A system according to claim 3 wherein the interlock switch disconnects other electric equipment in the vehicle from the battery during the charging session and reconnects the other electric equipment back to the battery when the charging session is completed.

5. A system according to claim 3 including a filter coupled between the interlock switch and the fan that filters large charge surges from the battery charger from reaching the fan.

6. A system according to claim 1 including a battery monitor that monitors battery parametric information, the battery monitor or the controller activating the fan when the charging session is detected and the battery monitor controlling the charging session with the battery charger according to a reduced battery temperature provided by the fan.

7. A system according to claim 6 wherein the controller monitors and stores vehicle operational data and then downloads the stored data to the battery monitor, the battery monitor then sending the data through a cable coupled between the battery monitor and the battery charger to a computer coupled to the battery charger.

8. A system according to claim 1 wherein the controller predicts an amount of remaining vehicle operating time according to both battery charge information and vehicle operating parameters.

9. A system according to claim 8 wherein the controller monitors and stores a profile of vehicle operation and adjusts the predicted amount of remaining vehicle operating time according to the vehicle operation profile.

10. A system according to claim 9 wherein the controller predicts a duration of an upcoming vehicle operating session, predicts whether or not the battery has enough charge to operate the vehicle for the predicted duration, and displays results of the predictions

11. A method for charging a battery, comprising:
detecting a charging session where a battery charger starts charging a battery located in a vehicle; and
automatically activating a fan in the vehicle to blow air on the battery when the charging session is detected.

12. The method according to claim 11 including detecting the charging session when a connector for the battery charger is physically coupled to a connector for the battery or when the battery charger starts supplying charge to the battery.

13. The method according to claim 11 including automatically directing energy from the battery charger to the fan and disconnecting other electrical equipment in the vehicle from the battery when the charging session is detected.

14. The method according to claim 13 including connecting the battery charger to the-fan during the charging session, disconnecting the battery charger from the fan at the completion of the charging session, and connecting the battery to the fan at the completion of the charging session to remove residual heat from the battery after the battery charger has been shut-off.

15. The method according to claim 11 including monitoring operating parameters for the battery and activating the fan according to the monitored battery operating parameters.

16. The method according to claim 11 including monitoring vehicle operation parameters and downloading the monitored vehicle operation parameters through the battery charger to a computer.

17. The method according to claim 111 including:
generating a vehicle operation profile identifying when and how long an electric motor in the vehicle is activated by the battery;
monitoring an amount of charge remaining in the battery; and
predicting an amount of time the battery can continue to operate the electric motor according to the monitored operation history and the monitored battery charge.

18. A method according to claim 11 including:
tracking past battery discharge rates while the battery is operating an electric motor in the vehicle;
measuring a charge remaining in the battery; and
predicting an amount of time the battery can operate the electric motor according to the tracked past battery discharge rates and the measured remaining charge in the battery.

19. A battery charging system for a vehicle, comprising:
a battery located in the vehicle for powering an electric motor used for locomotion in the vehicle;
a fan permanently installed in the vehicle and directed toward the battery;
a battery charger; and
a controller automatically activating the fan when the battery charger initiates charging of the battery.

20. A battery charging system according to claim 19 including switching circuitry in the vehicle that automatically maintains or connects power from the battery charges to the fan and automatically disconnects power from the battery charger from other vehicle electrical equipment while the battery charger charges the battery.
